(19) United States
(12) Patent Application Publication
(10) Pub. No.: US 2025/0265663 A1
(43) Pub. Date: Aug. 21, 2025

(54) System and Method for Using a Property Marketplace Platform

(71) Applicant: Propcents, Inc., Austin, TX (US)

(72) Inventors: Nhan Thanh VO, Austin, TX (US); Jeffrey Brian zakrzewski, Elkhorn, NE (US)

(21) Appl. No.: 19/056,659

(22) Filed: Feb. 18, 2025

Related U.S. Application Data
(63) Continuation of application No. 63/555,384, filed on Feb. 19, 2024.

(51) Int. Cl. G06Q 50/16; G06Q 40/03

(52) U.S. Cl. CPC G06Q 50/16; G06Q 40/03

(57) ABSTRACT

Various implementations directed to a system and method for using a property marketplace platform are provided. In one implementation, the method may include receiving, at a property marketplace platform, external data from one or more external data systems for a plurality of properties. The method may also include determining financing costs data for the plurality of properties based on the listings data and the property financing data. The method may further include determining a plurality of true cost (TC) values for the plurality of properties based on the listings data, the local costs data, and the financing costs data. The method may additionally include generating visualization data based on the plurality of TC values and the listings data. In addition, the method may include transmitting the visualization data to the user device.

### CROSS-REFERENCE TO RELATED APPLICATIONS

This application claims the benefit of U.S. provisional patent application Ser. No. 63/555,384, filed Feb. 19, 2024 and titled SYSTEM AND METHOD FOR USING A PROPERTY MARKETPLACE PLATFORM, the entire disclosure of which is herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

In various scenarios, a party may evaluate a number of financial considerations before deciding whether to conduct a property transaction, such as for a transaction to obtain possession of a property. For example, for a prospective buyer determining whether to purchase a real estate property, these financial considerations may include costs relating to a mortgage, property taxes, property insurance, and/or the like. In these various scenarios, having access to a total periodic (e.g., monthly) cost that accurately reflects such financial considerations may be helpful to the party (e.g., the prospective buyer).

### SUMMARY

Described herein are implementations of various technologies relating to a system and method for using a property marketplace platform. In one implementation, the method may include receiving, at a property marketplace platform, external data from one or more external data systems for a plurality of properties, where the external data comprises listings data, local costs data, property financing data for the plurality of properties, and credit profile data corresponding to a user, and where the local costs data comprises data relating to one or more utilities expenses. The method may also include determining financing costs data for the plurality of properties based on the listings data and the property financing data, where the financing costs data for a respective property corresponds to a value of a periodic financing cost associated with possessing the respective property. The method may further include determining a plurality of true cost (TC) values for the plurality of properties based on the listings data, the local costs data, and the financing costs data, wherein a respective TC value for the respective property corresponds to a value of a total periodic cost associated with possessing the respective property. The method may additionally include generating visualization data based on the plurality of TC values and the listings data, wherein the visualization data is configured for use in generating one or more interfaces for a user device associated with the user. In addition, the method may include transmitting the visualization data to the user device.

In another implementation, a property marketplace platform may include one or more processors and a memory having a plurality of program instructions which, when executed by the one or more processors, cause the one or more processors to receive external data from one or more external data systems for a plurality of properties, where the external data comprises listings data, local costs data, property financing data for the plurality of properties, and credit profile data corresponding to a user, and where the local costs data comprises data relating to one or more utilities expenses. The one or more processors may also determine financing costs data for the plurality of properties based on the listings data and the property financing data, wherein the financing costs data for a respective property corresponds to a value of a periodic financing cost associated with possessing the respective property. The one or more processors may further determine a plurality of true cost (TC) values for the plurality of properties based on the listings data, the local costs data, and the financing costs data, wherein a respective TC value for the respective property corresponds to a value of a total periodic cost associated with possessing the respective property. The one or more processors additionally generate visualization data based on the plurality of TC values and the listings data, wherein the visualization data is configured for use in generating one or more interfaces for a user device associated with the user. The one or more processors may also transmit the visualization data to the user device.

In yet another implementation, a non-transitory computer-readable medium having stored thereon a plurality of computer-executable instructions which, when executed by a computer, cause the computer to receive external data from one or more external data systems for a plurality of properties, where the external data comprises listings data, local costs data, property financing data for the plurality of properties, and credit profile data corresponding to a user, and where the local costs data comprises data relating to one or more utilities expenses. The computer may also determine financing costs data for the plurality of properties based on the listings data and the property financing data, where the financing costs data for a respective property corresponds to a value of a periodic financing cost associated with possessing the respective property. The computer may further determine a plurality of true cost (TC) values for the plurality of properties based on the listings data, the local costs data, and the financing costs data, where a respective TC value for the respective property corresponds to a value of a total periodic cost associated with possessing the respective property. The computer may also generate visualization data based on the plurality of TC values and the listings data, where the visualization data is configured for use in generating one or more interfaces for a user device associated with the user. The computer may further transmit the visualization data to the user device.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a system using a property marketplace platform in accordance with implementations of various techniques described herein.

FIGS. 2-7 illustrate graphical interfaces in accordance with implementations of various techniques described herein.

FIG. 8 illustrates a flow diagram of a method for using a property marketplace platform in accordance with implementations of various techniques described herein.

FIG. 9 illustrates a block diagram of a hardware configuration in which one or more various technologies described herein may be incorporated and practiced.

### DETAILED DESCRIPTION

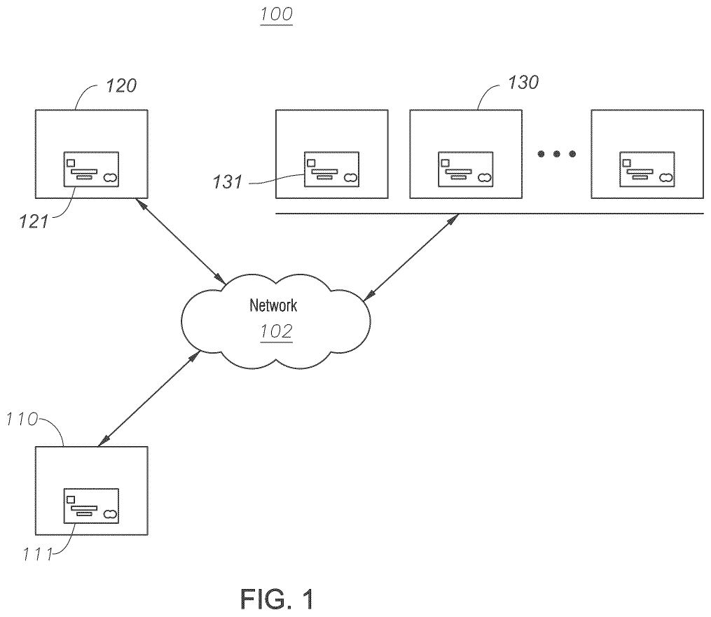

Various implementations directed to a system and method for using a property marketplace platform will now be described in the following paragraphs with reference to FIGS. 1-9.

As noted above, a party may evaluate one or more financial considerations before deciding whether to conduct a property transaction, such as for a transaction to obtain possession of a property. Property may refer to any type of property known in the art, including, but not limited to, real property, real estate property, personal property, intellectual property, and/or the like. While implementations disclosed herein may be discussed in terms of real estate property, those skilled in the art will understand that these implementations may apply to any other type of property known in the art. Further, obtaining possession of the property may refer to any activity that relates to using, and/or exercising dominion over, the property. Such activity may include purchasing the property, leasing the property, renting the property, licensing the property, and/or the like.

As is known in the art, the party may include any potential transactor who has an interest in conducting the property transaction, where the party may be an individual, a group of individuals, a partnership, an entity, and/or the like. In one example, the potential transactor may be a prospective buyer who has an interest in purchasing a real estate property. In another example, the potential transactor may be a prospective renter who has an interest in leasing a real estate property.

The one or more financial considerations evaluated by the party may include any cost known in the art that relates to possession of the property. In one implementation, the one or more financial considerations may include one or more financing costs. A financing cost may be a periodic cost associated with obtaining possession of the property, where “periodic” may refer to any period of time (e.g., monthly, yearly, etc.). For example, the financing cost may correspond to a monthly mortgage payment associated with purchasing the property, a monthly rent payment associated with leasing the property, and/or the like.

In another implementation, the one or more financial considerations may include one or more local costs. The one or more local costs may include one or more costs associated with possessing a specific property. In particular, a local cost may correspond to an expense associated with a specific geographic area (e.g., a street, neighborhood, subdivision, city, state, etc.) in which the specific property is located. For example, a local cost may include an expense relating to property taxes, property insurance, a homeowners' association fee, and/or the like.

The party (e.g., the potential transactor) may utilize such financial considerations to assess whether obtaining possession of the property would be a financially prudent decision. For example, the party may be a prospective buyer determining whether to purchase a real estate property. In such an example, the prospective buyer may conclude that this real estate property would be an affordable purchase based on an evaluation of one or more financing costs (e.g., an estimated monthly mortgage payment) associated with such a purchase. However, in a further example, the prospective buyer may determine that this real estate property is actually not an affordable purchase after considering the one or more local costs (e.g., one or more expenses relating to property taxes, property insurance, a homeowners' association fee, and/or the like) associated with the property. Thus, having access to a total cost that accurately and thoroughly reflects these financial considerations for a property may be helpful to the party (e.g., the prospective buyer), particularly when determining the affordability of a property transaction.

Accordingly, in view of the above, various implementations for a system and/or a method for using a property marketplace platform are described herein, where the property marketplace platform may also be referred to herein as the “platform.” In one implementation, the property marketplace platform may be used to facilitate property transactions by generating true cost (TC) values for various properties (e.g., real estate properties), where such TC values may be provided to parties (e.g., buyers, agents, brokers, and/or the like) associated with the property transactions.

### I. System

FIG. 1 illustrates a schematic diagram of a system 100 using a property marketplace platform 120 in accordance with implementations of various techniques described herein. As shown, the system 100 may include one or more networks 102, a user 110, the property marketplace platform 120, and one or more external data providers 130.

Using one or more respective computing devices (as further described below), the user 110, the property marketplace platform 120, and the one or more external data providers 130 may be in communication with one another via the one or more networks 102. The one or more networks 102 may include, but are not limited to, one or more of the following components: a local area network (LAN), a wide area network (WAN) (e.g., the Internet), a mobile network, a cellular network, a virtual network, and/or any other public and/or private network known in the art capable of supporting any type of communication among two or more of the elements of the system 100.

The user 110 may be a party who has an interest in conducting a property transaction, such as a transaction to obtain possession of a property. As similarly described above, the property may refer to any type of property known in the art, including, but not limited to, real property, real estate property, personal property, intellectual property, and/or the like. In addition, as similarly described above, obtaining possession of the property may include any activity relating to using, and/or exercising dominion over, the property. Such activity may include purchasing the property, leasing the property, renting the property, licensing the property, and/or the like.

Further, the user 110 may be an individual, a group of individuals, a partnership, an entity, and/or the like. In one implementation, the user 110 may be similar to the party described above, such that the user 110 may include any potential transactor who has an interest in obtaining possession of a property via a property transaction. In one example, the user 110 may be a prospective buyer who has an interest in purchasing a real estate property. In another example, the user 110 may be a prospective renter who has an interest in leasing a real estate property. In further implementations, the user 110 may be an agent, a broker, and/or any other representative of a potential transactor (e.g., a prospective buyer) who has an interest in obtaining possession of a property via a property transaction.

In addition, the user 110 may own, operate, and/or be involved with at least one computing device 111. The at least one computing device 111 may include any type and/or number of computing devices known to those skilled in the art, including one or more mobile devices, one or more tablet devices, one or more laptop devices, and/or the like. Various implementations of the at least one computing device 111 are discussed in a later section. As further explained below, the at least one computing device 111 may be configured to perform one or more operations described herein, including communicating with the property marketplace platform 120 via the one or more networks 102. Further, while one or more operations may be described herein as being performed by a single computing device 111 of the user 110, those skilled in the art will understand that these operations may be performed by a plurality of computing devices 111 of the user 110.

The property marketplace platform 120 may be utilized by the user 110 to facilitate the property transaction described above. In some implementations, the property marketplace platform 120 may be operated by and/or provided by an entity, where the entity may be unrelated to, and/or unaffiliated with, the user 110 and/or the one or more external data providers 130. In addition, the property marketplace platform 120 may be a software-based system, a hardware-based system, or combinations thereof. In particular, the property marketplace platform 120 may include, and/or may be implemented using, at least one computing device 121. The at least one computing device 121 may include any type and/or number of computing devices known to those skilled in the art, including one or more servers, one or more cloud computing systems, and/or the like. Various implementations of the at least one computing device 121 are discussed in a later section.

As further explained below, the property marketplace platform 120 (i.e., via the at least one computing device 121) may be configured to perform one or more operations described herein. In one implementation, the one or more operations that may be performed by the at least one computing device 121 may include: receiving user data from the user 110, receiving external data from the one or more external data providers 130 for a plurality of properties, determining financing costs data corresponding to the user 110 for the plurality of properties based on the user data and the external data, determining a plurality of true cost (TC) values for the plurality of properties based on the external data and the financing costs data, filtering the plurality of properties based on the plurality of TC values, generating visualization data based on the plurality of TC values and the filtered properties, and/or transmitting the visualization data to the at least one computing device 111. Further, while one or more operations may be described herein as being performed by a single computing device 121 for the property marketplace platform 120, those skilled in the art will understand that these operations may be performed by a plurality of computing devices 121 for the property marketplace platform 120.

The one or more external data providers 130 may include one or more entities that collect and/or manage any data that relates to a property, possession of a property, and/or a property transaction. Such data may hereinafter be referred to as “external data.” In particular, each external data provider 130 may store and/or maintain its external data in one or more databases. In some implementations, each external data provider 130 may be operated by and/or provided by an entity, where the entity may be unrelated to, and/or unaffiliated with, the user 110, the platform 120, and/or other external data providers 130.

In one implementation, the external data stored and/or maintained by the one or more external data providers 130 may include listings data. The listings data may include data relating to one or more property listings. As is known in the art, a property listing may be an advertisement and/or publication that includes information about a property that is available for sale, rent, and/or lease. Such information may include a listing price, property size (e.g., square footage), property features (e.g., a number of bedrooms, a number of bathrooms, etc.), one or more photographs, one or more videos, and/or the like. An external data provider 130 that provides listings data may be referred to herein as a listings provider. In particular, one or more listings providers may store and/or maintain the data in one or more listings databases. Such databases may include one or more Multiple Listing Service (MLS) databases, one or more online listings databases, one or more newspaper listings databases, one or more non-MLS databases, and/or any other listings database known to those skilled in the art.

In another implementation, the external data stored and/or maintained by the one or more external data providers 130 may include local costs data. The local costs data for a property may include data relating to one or more local costs for that property. As explained above, the one or more local costs may include one or more costs associated with possessing a specific property. In particular, a local cost may correspond to an expense associated with a specific geographic area (e.g., a street, neighborhood, subdivision, city, state, etc.) in which the specific property is located. In one example, the local costs data for a property may include data relating to property tax costs. In such an example, an external provider 130 that provides such data may be referred to as a tax provider, where one or more tax providers may store and/or maintain the data in one or more tax databases. Such databases may include one or more public assessor databases, one or more tax record databases, and/or any other tax database known to those skilled in the art. In another example, the local costs data for a property may include data relating to property insurance costs (e.g., homeowner's insurance expenses). In such an example, an external provider 130 that provides such data may be referred to as an insurance provider, where one or more insurance providers may store and/or maintain the data in one or more insurance databases. In yet another example, the local costs data for a property may include data relating to homeowners' association (HOA) costs (e.g., annual HOA fees). In such an example, an external provider 130 that provides such data may be referred to as an HOA provider, where one or more HOA providers may store and/or maintain the data in one or more HOA databases. Such databases may include one or more public HOA databases, one or more private HOA databases, and/or any other HOA database known to those skilled in the art. In an additional example, the local costs data for a property may include data relating to one or more utility costs. In such an example, an external provider 130 that provides such data may be referred to as a utility provider, where one or more utility providers may store and/or maintain the data in one or more utility databases. The one or more utility providers may refer to any utility provider known to those skilled in the art, including, but not limited to, entities that provide utility services for water, electricity, gas, sewage, sewerage, waste, sanitation, internet access, and/or the like.

In yet another implementation, the external data stored and/or maintained by the one or more external data providers 130 may include property financing data. The property financing data may include data relating to a property financing market. In one implementation, the property financing market may correspond to a market value for one or more mortgage interest rates, one or more mortgage types, one or more requirements for a mortgage, and/or the like. In another implementation, the property financing market may correspond to an estimated monthly rental amount for a property, such as an automated valuation model (AVM). An external data provider 130 that provides property financing data may be referred to herein as a property financing provider, which may be a public financial services corporation, a private banking institution, and/or the like. In particular, one or more property financing providers may store and/or maintain the data in one or more property financing databases. Such databases may include one or more public databases (e.g., a database associated with the public financial services corporation), one or more private databases (e.g., a database associated with the private banking institution), and/or any other property financing database known to those skilled in the art.

In another implementation, the external data stored and/or maintained by the one or more external data providers 130 may include credit profile data. The credit prolife data may include any data relating to a credit profile of the user 110. As is known in the art, such data may correspond to a credit history of the user 110, a credit score (e.g., a FICO score) of the user 110, a credit rating of the user 110, and/or the like. An external data provider 130 that provides credit prolife data may be referred to herein as a credit prolife provider. In particular, one or more credit prolife providers may store and/or maintain the data in one or more credit prolife databases. In one example, the one or more credit profile providers may include one or more credit agencies.

The one or more external data providers 130 may own, operate, and/or be involved with at least one computing device 131. The one or more external data providers 130 may utilize the at least one computing device 131 to host, implement, and/or provide the one or more databases of external data mentioned above. The at least one computing device 131 may include any type and/or number of computing devices known to those skilled in the art, including one or more servers, one or more cloud computing systems, and/or the like. Various implementations of the at least one computing device 131 are discussed in a later section. As further explained below, the at least one computing device 131 may be configured to perform one or more operations described herein, including communicating with the property marketplace platform 120 via the one or more networks 102.

In addition, the one or more computing devices mentioned above (e.g., the at least one computing device 111) may be configured to perform one or more operations as described herein using one or more applications downloaded to, installed in, and/or activated in these one or more computing devices. In one implementation, the entity operating and/or providing the platform 120 may also provide and/or host the one or more applications, as further described below. Additionally, the one or more computing devices mentioned above may communicate with one another using any technique known to those skilled in the art. In one example, though not shown in FIG. 1, these one or more computing devices may communicate with one another using one or more application programming interfaces (APIs) associated with the one or more applications. In another example, the one or more applications used by at least some of the computing devices may include a web browser, such that the web browser may be used to communicate with other computing devices of the system 100 via the one or more networks 102.

Moreover, although the system 100 is presented in one arrangement, other implementations may include one or more elements of the system 100 in different arrangements and/or with additional elements. For example, though one user 110 and one computing device 111 are shown in FIG. 1, those skilled in the art will understand that the implementations described herein may be applied to scenarios in which multiple users 110 and/or multiple computing devices 111 communicate with the platform 120. In another example, though a single external data provider 130 is illustrated in FIG. 1, those skilled in the art will understand that the implementations described herein may be applied to scenarios in which multiple external data providers 130 communicate with the platform 120.

### II. Operation

One or more elements of the system 100 may be used to perform one or more operations, such as those described herein, in order to facilitate property transactions for a user 110. In one implementation, and as further described below, the property marketplace platform 120 and the computing devices described herein may be used to: receive user data from the user 110, receive external data from the one or more external data providers 130 for a plurality of properties, determine financing costs data corresponding to the user 110 for the plurality of properties based on the user data and the external data, determine a plurality of TC values for the plurality of properties based on the external data and the financing costs data, filter the plurality of properties based on the plurality of TC values, generate visualization data based on the plurality of TC values and the filtered properties, and/or transmit the visualization data to a computing device (e.g., the computing device 111). Again, while the implementations below are discussed in terms of real estate properties, those skilled in the art will understand that these implementations may also be applicable to any other type of property known in the art.

### A. User Registration

Before the property marketplace platform 120 can be used to facilitate property transactions for a user 110, the user 110 may need to complete a user registration process with the platform 120. To do so, prior to starting the user registration process, the user 110 may use the at least one computing device 111 to download, install, and/or activate an application associated with the platform 120. As noted above, the entity operating and/or providing the platform 120 may also provide and/or host the application. Via the application, the user 110 may use the computing device 111 to communicate with the platform 120 via the one or more networks 102. In some implementations, the user 110 may be a prospective buyer who uses the computing device 111 to download, install, and/or activate an application that is designated specifically for prospective buyers and/or sellers. In other implementations, the user 102 may be an agent and/or a broker for a prospective buyer who uses the communications device 110 to download, install, and/or activate an application that is designated specifically for agents and/or brokers. In another implementation, the user 102 may be a third party involved with the property transaction, such as an escrow agent, a loan officer, a lender, a title agent, an escrow agent, and/or the like. In such an implementation, the user 102 may utilize an application that is designated specifically for such third parties.

While the implementations below are discussed in terms of an application installed on the computing device 111, those skilled in the art will understand that other implementations may be applicable, as well. For example, in a further implementation, the user 110 may use a web browser installed on the computing device 111 to communicate with the platform 120 via the one or more networks 102. In particular, the entity operating and/or providing the platform 120 may provide and/or host a web portal through which the user 110 may access the platform 120.

### 1. User Profile Data

After the application has been downloaded, installed, and/or activated on the computing device 111, the user 110 may begin the registration process. In particular, the computing device 111 may, via the application, display a prompt indicating that the user 110 is to provide user profile data for the user 110. The user 110 may then provide the user profile data to the application via one or more input devices of the computing device 111. In one implementation, the user 110 may be prompted to provide user profile data that includes data corresponding to a username, a password, and/or the like for the user 110.

In one implementation, the user 110 may also be prompted to provide profile data that includes data corresponding to biographical information associated with the user 110, where the user 110 may also be a potential transactor who has an interest in obtaining possession of a property via a property transaction. In particular, the data corresponding to the user 110 may relate to a name, location, occupation, one or more personal identification numbers (e.g., a social security number), one or more financial accounts (e.g., one or more bank accounts, one or more credit card accounts, etc.), and/or any other personal information associated with the user 110. In one example, the location may be determined using the computing device 111 in conjunction with one or more satellite navigation systems (e.g., the Global Positioning System (GPS)).

After the user 110 provides the user profile data to the computing device 111 (e.g., via the application), the computing device 111 may then transmit the user profile data to the property marketplace platform 120. After receiving the user profile data, the property marketplace platform 120 may store the data in one or more databases located in memory (e.g., one or more computer-readable storage media) associated with the computing device 121. The one or more databases may be generated or organized using any techniques known to those skilled in the art. The property marketplace platform 120 may then generate a user profile for the user 110 based on the user profile data. The property marketplace platform 120 may store data corresponding to the user profile in the one or more databases, thereby completing the user registration process for the user 110.

### 2. User Financing Data

In a further implementation, where the user 110 may also be a potential transactor who has an interest in obtaining possession of a property via a property transaction, the user 110 may also provide user financing data to the application via one or more input devices of the computing device 111. In one such implementation, the user 110 may be a prospective buyer of real estate property, such that the user financing data may correspond to the user's selections for a credit rating, a down payment value, a mortgage product type, and/or a mortgage rate for conducting a transaction to purchase such a property.

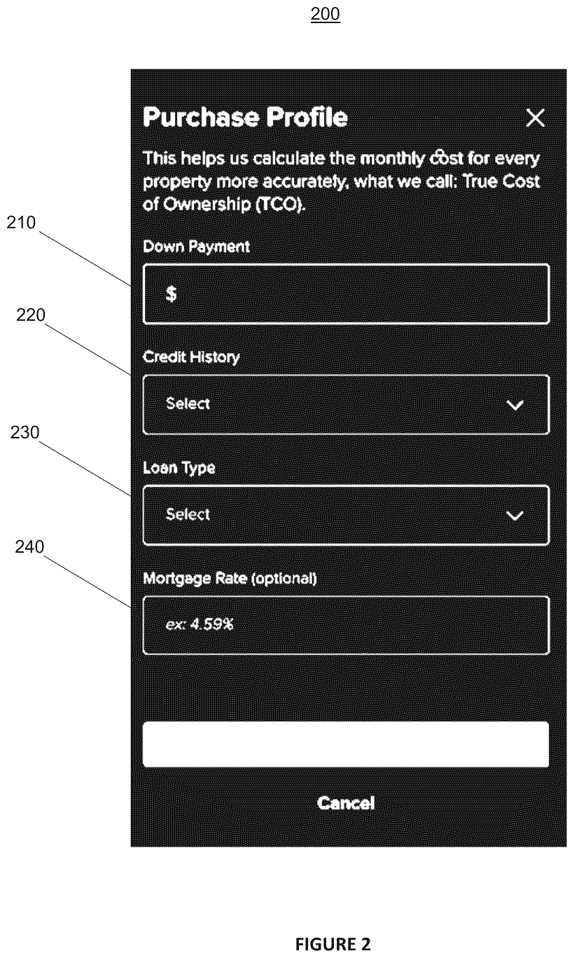

For example, FIG. 2 illustrates a graphical interface 200 in accordance with implementations of various techniques described herein, where the computing device 111 may be configured to display the graphical interface 200 to the user 110. As shown, the graphical interface 200 may display a plurality of input fields, including an entry field 210 for a down payment value, a dropdown box 220 for a credit history selection, a dropdown box 230 for a loan type selection, and an entry field 240 for a mortgage rate value. Using these input fields and the one or more input devices of the computing device 111, the user 110 can provide user financing data relating to the user's 110 interest in purchasing a real estate property.

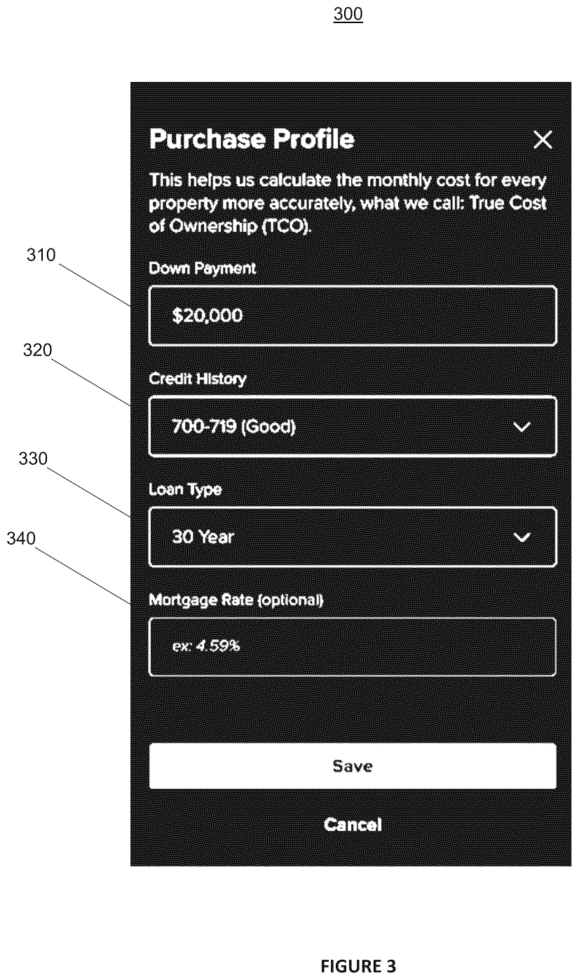

FIG. 3 illustrates a graphical interface 300 in accordance with implementations of various techniques described herein, where the computing device 111 may be configured to display the graphical interface 300 to the user 110. As shown, the graphical interface 300 may display a plurality of input fields after the user 110 has provided the user financing data via the computing device 111. As shown, the plurality of input fields 310-340 may correspond to the input fields 210-240 described above.

In one example, the user's 110 selection for the credit rating may indicate whether the user 110 has a credit rating of poor, fair, good, very good, and so forth. And, as further described in a later section, the platform 120 may validate the user's 110 selection for the credit rating using any method known in the art, including by validating the selection using the credit profile data discussed herein. In another example, the user's 110 selection for the down payment value may indicate a down payment amount (e.g., 20,000 dollars) that the user 110 is willing to provide for a transaction to purchase a real estate property, a percentage (e.g., 20 percent) of a sales price for the real estate property that the user 110 is willing to provide as a down payment for the transaction, and/or any other value known to those in the art. In yet another example, the user's 110 selection for the loan type may indicate a type of mortgage product (e.g., a 30-year fixed rate mortgage, a 15-year fixed rate mortgage, a 5-year adjustable rate mortgage, or the like) preferred by the user 110 when conducting the property transaction. In an additional example, the user's 110 selection for the mortgage rate may indicate the user's preferred mortgage interest rate for the property transaction.

After the user 110 provides the user financing data to the computing device 131 (e.g., via the application), the computing device 131 may then transmit the user financing data to the property marketplace platform 120. The platform 120 may store the user financing data in its one or more databases, such that the data may be associated with the user 110 in the one or more databases.

### B. External Data

Before the platform 120 can facilitate a property transaction for a user 110 by providing a plurality of TC values to the user 110, the platform 120 may need to receive external data from the one or more external data providers 130 (i.e., via one or more computing devices 131). In one implementation, the property marketplace platform 120 may initially transmit external provider request data to the one or more external data providers 130, where the external provider request data may correspond to a request that the external providers 130 provide the requested external data.

Upon receiving the external provider request data, the one or more external providers 130 (i.e., via the one or more computing devices 131) may transmit the external provider data to the platform 120, as requested. After receiving the external provider data, the platform 120 may store the data in one or more databases located in memory (e.g., one or more computer-readable storage media) associated with the computing device 121. In a further implementation, the platform 120 may be configured to communicate with the one or more external providers 130 (i.e., via the one or more computing devices 131) using one or more APIs, as mentioned above.

### 1. Listings Data

As mentioned above, the external data may include listings data, where such data relates to one or more property listings. The property marketplace platform 120 may receive the listings data from one or more listings providers, where these providers store and/or maintain the data in one or more listings databases (e.g., one or more Multiple Listing Service (MLS) databases, one or more online listings databases, one or more newspaper listings databases, one or more non-MLS databases, and/or any other listings database known to those skilled in the art).

In particular, the listings data may correspond to information from property listings (e.g., real estate listings) associated with these properties. For example, for a real estate listing associated with a specific real estate property, the property listings data for the property may correspond to location information, a listing price, square footage, a number of bedrooms, a number of bathrooms, one or more photographs, one or more videos, and/or the like. In a further implementation, the platform 120 may receive the listings data on a continuous and/or periodic basis from the one or more third-party data sources 130, such that the property listings data may correspond to real-time or near real-time information associated with these properties.

### 2. Local Costs Data

In another implementation, the external data may include local costs data for the properties (e.g., real estate properties) located within the one or more geographic regions. In particular, the local costs data may correspond to information relating to one or more local costs for the properties, where the information may be for specific properties and/or for specific geographic regions (e.g., street, neighborhood, subdivision, city, state, and/or the like) in which the properties are located. As noted above, the property marketplace platform 120 may receive the local costs data from any type and/or number of data sources associated with a local expense for a property.

In some implementations, the local costs data for a specific real estate property and/or a specific geographic region may include data corresponding to property tax information, insurance expenses information, HOA fees information, utilities expenses information, and/or the like. In one example, the platform 120 may acquire the data corresponding to property tax information from one or more data sources associated with property taxes, where such data sources may include one or more public assessor databases and/or one or more tax record databases. In another example, the platform 120 may acquire the data corresponding to insurance expenses information (e.g., homeowner's insurance expenses information) from one or more data sources associated with insurance expenses, where such data sources may include data provided by one or more insurance providers (e.g., one or more homeowner's insurance providers). In such an example, the insurance expenses information may include pro rata insurance expense information (e.g., cost per square foot) for a specific geographic region (e.g., street, neighborhood, subdivision, city, state, and/or the like) in which a property is located.

In yet another example, the platform 120 may acquire the data corresponding to HOA fees information from one or more data sources associated with HOA fees (e.g., one or more public databases) and/or may extract the data from the property listings data mentioned above. In an additional example, the platform may acquire the utilities expenses information from one or more data sources associated with utilities expenses, where such data sources may include data provided by one or more utility providers. In such an example, the utilities expenses information may include pro rata utilities expense information (e.g., cost per square foot) for a specific geographic region (e.g., street, neighborhood, subdivision, city, state, and/or the like) in which a property is located. As mentioned above, the one or more utility providers may refer to any utility provider known to those skilled in the art, including, but not limited to, entities that provide services for water, electricity, gas, sewage, sanitation, internet access, and/or the like.

### 3. Property Financing Data

In yet another implementation, the external data may include property financing data. The property financing data may include data relating to a property financing market. In one implementation, the property financing market may correspond to a market value for one or more mortgage interest rates, one or more mortgage types, one or more requirements for a mortgage, and/or the like. In another implementation, the property financing market may correspond to an estimated monthly rental amount for a property, such as an automated valuation model (AVM). In particular, for a potential property transaction (e.g., a real estate property transaction), the property financing data may reflect real-time or near-real time market values associated with the one or more interest rates, the one or more loan types, the one or more loan requirements, estimated monthly rental amount, and/or the like.

As mentioned above, the property marketplace platform 120 may receive the property financing data from any data source known in the art, including one or more public databases (e.g., a database associated with a public financial services corporation), one or more private databases (e.g., a database associated with a private banking institution), and/or the like. In one example, the data corresponding to the current market for interest rates may indicate the current mortgage interest rate values (e.g., a mortgage par rate) for different mortgage products and/or for buyers with various credit ratings. In another example, the data corresponding to the current market for loan types may indicate the current mortgage products being offered by public and/or private lenders. In yet another example, the data corresponding to the current market for loan requirements may indicate the current qualification requirements that are to be satisfied in order for buyers to avail themselves of the currently available mortgage products. In one such example, the data may include one or more matrices provided by a public financial services corporation, where the current qualification requirements can be derived from said matrices.

### 4. Credit Profile Data

In another implementation, the external property data may include credit profile data for the prospective buyer. The credit profile data may include data corresponding to a credit rating, a credit history, and/or the like for the buyer. As mentioned above, the property marketplace platform 120 may receive the credit profile data from any data source known in the art, including one or more credit agency databases.

In one example, the data corresponding to the credit rating may indicate one or more current credit ratings (e.g., a FICO score) for the prospective buyer that have been determined by one or more credit agencies. In another example, the data corresponding to the credit history may relate to one or more debt accounts (e.g., a credit card account) of the prospective buyer. As further described in a later section, the platform 120 may utilize the credit profile data to validate the user financing data provided by the user 110, such as for validating the prospective buyer's selection for a credit rating.

### C. TC Values

After receiving the profile data and/or the external data as described above, the platform 120 may generate the TC values for various properties (e.g., real estate properties) and then provide the generated TC values to the user 102 (i.e., via the communications device 110). In one implementation, the TC value may correspond to a total cost of ownership (TCO) value relating to ownership expenses, where the TCO value may be equal to a value of monthly ownership expenses associated with that property. In another implementation, the TC value may correspond to a total cost of rent (TCR) value relating to renting expenses, where the TCR value may be equal to a value of monthly rental expenses associated with that property.

### 1. Using Default Monthly Financing Expenses

In one implementation, the platform 120 may determine the TC values for the prospective buyer based on the received property listings data, local expenses data, and/or loan market data. First, the platform 120 may identify each property included in the received listings data. Then, based on the received local costs data, the platform 120 may determine a value of total monthly local costs for each identified property. As described above, the total monthly local costs for each identified property may include property tax expenses, insurance expenses, HOA fees, and utilities expenses (e.g., expenses for water, electricity, gas, sewage, sanitation, internet access, and/or the like). The platform 120 may store these values in in its associated memory, such as in one or more of its associated databases.

Further, based on the received property financing data, the platform 120 may determine a value of default monthly financing expenses for each identified property. The default monthly financing expenses for a property may correspond to expenses associated with obtaining a mortgage for that property, such as values for principal, interest, mortgage insurance, and monthly mortgage payments. In one example, to determine the value of such expenses, the platform 120 may first assign default selections for the prospective buyer. These default selections may include a specific credit rating (e.g., a fair rating), a specific down payment value (e.g., is willing to provide a down payment that is equal to 20% of a property's sales price), and a specific loan type (e.g., a 30-year fixed rate mortgage).

Then, for each identified property, the platform 120 may determine a specific interest rate (e.g., a mortgage par rate) that corresponds to the default selections. In particular, the platform 120 may determine the specific interest rate based on the received loan market data (e.g., data corresponding to a current market for one or more interest rates, one or more loan types, and one or more loan requirements). The platform 120 may then determine the value of the default monthly financing expenses for each identified property based on the default selections and the determined interest rate. The platform 120 may also store these values in in its associated memory, such as in one or more of its associated databases.

In one implementation, using these determined values of total monthly local expenses and default monthly financing expenses, the platform 120 may be able to determine a TCO value for each identified property. The platform 120 may store these TCO values in in its associated memory, such as in one or more of its associated databases. In another implementation, the platform 120 may be able to determine a TCR value for each identified property based on listings data and the utilities expenses derived from the external data.

### 2. Using Personalized Monthly Financing Expenses

In another implementation, the platform 120 may determine the TC values for the prospective buyer based on the received property listings data, local costs data, property financing data, the credit profile data, and the user financing data. In such an implementation, the platform 120 may determine a value of total monthly local expenses for each identified property in a similar manner as described above.

Further, based on the property financing data, the credit profile data, and the user financing data, the platform 120 may determine a value of personalized monthly financing expenses for each identified property. The personalized monthly financing expenses for a property may correspond to expenses associated with obtaining a mortgage for that property for a specific prospective buyer, where such expenses may include values for principal, interest, mortgage insurance, and monthly mortgage payments.

In one example, to determine the value of such expenses, the platform 120 may derive the prospective buyer's selections from the user financing data, which may include selections for a credit rating, a down payment value, and/or a loan type for a potential real estate transaction. The platform 120 may then validate the user's selection for the credit rating based on the credit profile data, which may be used to avoid errors and/or ensure accurate calculations relating to the user's credit rating.

If the credit rating is validated, the platform 120 may determine a specific interest rate (e.g., a mortgage par rate) that corresponds to the user's selections. In particular, the platform 120 may determine the specific interest rate based on the received property financing data (e.g., data corresponding to a current market for one or more interest rates, one or more loan types, and one or more loan requirements), such as by determining a loan-to-value (LTV) ratio for each identified property. The platform 120 may then determine the value of the personalized monthly financing expenses for each identified property based on the user's selections and the determined interest rate. The platform 120 may also store these values in in its associated memory, such as in one or more of its associated databases.

In one implementation, using these determined values of total monthly local expenses and personalized monthly financing expenses, the platform 120 may be able to determine a TCO value for each identified property for a specific prospective buyer. The platform 120 may store these TCO values in in its associated memory, such as in one or more of its associated databases. In another implementation, the platform 120 may be able to determine a TCR value for each identified property based on listings data and the utilities expenses derived from the external data.

### D. Filtered Listings Data

In some implementations, the platform 120 may be configured to filter the listings data based on the determined TCO values and the external data. In particular, the user 110 may provide filter input data to the device 111 via the above-mentioned application, where the filter input data may indicate criteria for searching and/or filtering the properties associated with the listings data. Such criteria may include a designated range of TC values, one or more designated geographic regions, a designated range of square footage, specific utility requirements, and/or the like.

The platform 120 may filter the listings data based on the filter input data, such that the platform 120 may generate filtered listings data corresponding to the filter results. The filtered listings data may indicate the properties associated with the listings data that satisfy the criteria indicated by the user 110.

The platform 120 may generate visualization data that corresponds to the filtered listings data and the TC values. In one example, the visualization data may correspond to a list view of the identified properties with their associated TC values. Each listing of an identified property may also include information relating to its property listings data, one or more hyperlinks to view such information, and/or the like. In another example, the display data may correspond to a map view of the identified properties with their associated TC values. Each identified property may be associated with a symbol on a map, where the symbol may also include its associated TC value. The symbol may also provide one or more hyperlinks to view information relating to the property listings data for the property. Further, a graphical interface generated by the device 111 based on the map view may be manipulated by the user 102 to display more or fewer of the identified properties, including by drawing boundaries onto the map view. In addition, for either the list view of the map view, the associated TC values displayed by the device 111 may be updated in real-time or in near real-time based on updated data from the platform 120, such as in response to -time or in near real-time changes in location based on satellite navigation data.

The platform 120 may provide the visualization data to the device 111. Upon receiving the visualization data from the platform 120, the device 111 may generate a graphical interface that corresponds to the visualization data including by corresponding to a list view or a map view.

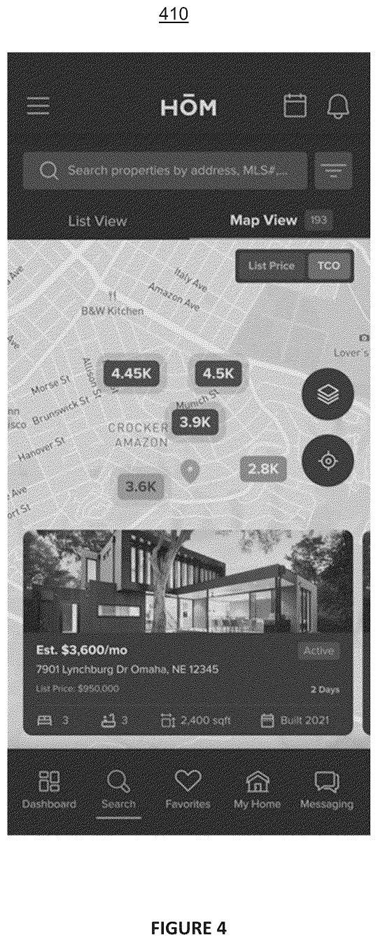

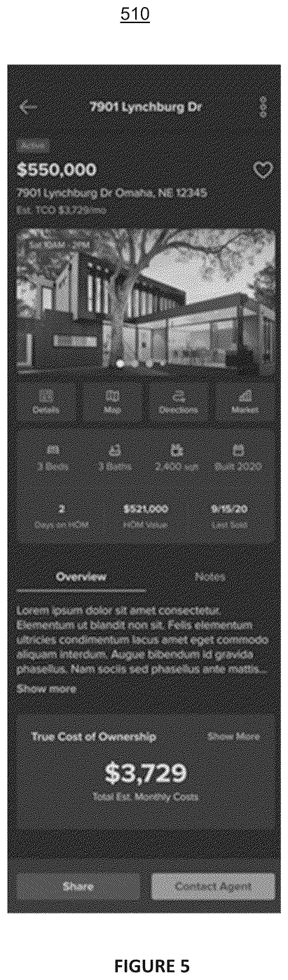

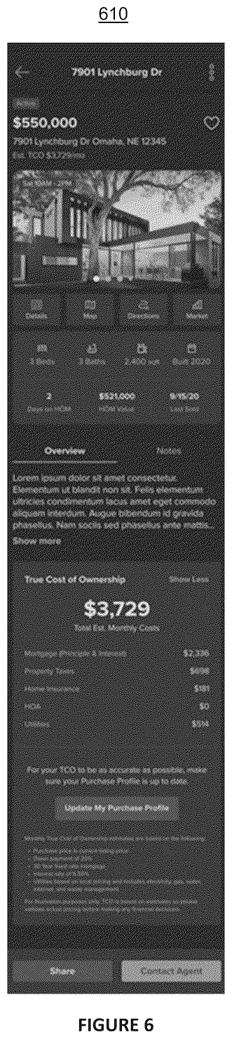

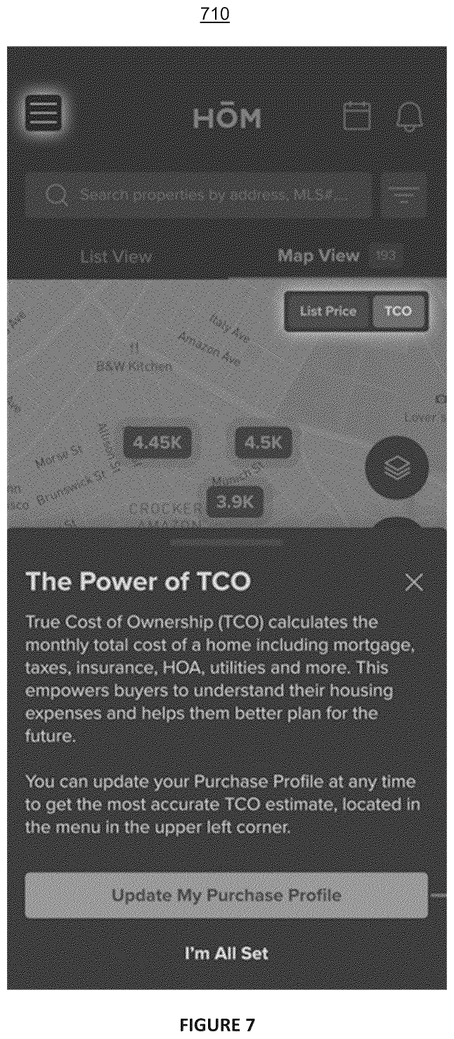

FIGS. 4-7 illustrate various graphical interfaces relating to the computing device 111 generating interfaces based on display data received from the platform 120. In particular, FIG. 4 illustrates a schematic diagram of a graphical interface 410 in accordance with implementations of various techniques described herein, where the computing device 111 may be configured to generate the interface 410 based on display data that corresponds to a map view of properties with their associated TCO values. FIG. 5 illustrates a schematic diagram of a graphical interface 510 in accordance with implementations of various techniques described herein, where the communications device 110 may be configured generate to the interface 510 in response to the user 110 using a hyperlink to view additional information for a specific property. Similarly, FIG. 6 illustrates a schematic diagram of a graphical interface 610 in accordance with implementations of various techniques described herein, where the computing device 111 may be configured generate the interface 610 in response to the user 110 using a hyperlink to view additional information for a specific property. FIG. 7 illustrates a schematic diagram of a graphical interface 710 in accordance with implementations of various techniques described herein, where the computing device 111 may be configured generate the interface 710 to allow the user 110 to update selections for the prospective buyer so that, in turn, the associated TCO values displayed by the computing device 111 may be updated.

### F. Other Features

In one implementation, the platform 120 may be configured to provide a user 110 with one or more recommendations of properties based on the profile data provided by the user (e.g., the buyer financing data) and/or other criteria provided by the user. Thus, the recommendations may be based on the financial capabilities and preferences of the user 110. By analyzing the user's input data, personalized property suggestions may be generated. Such a feature may assist a user with finding the most suitable properties within their budget, eliminating the need for extensive manual search and analysis. In one such implementation, the platform 120 may be configured to generate the recommendations using machine learning, neural networks, and/or the like.

In another implementation, a user 110 can save properties of interest to an associated user profile, which may allow the platform 120 to then compare the monthly costs of the properties before making a purchasing decision. This feature may allow a user to track and compare multiple properties, enabling the user to assess factors such as affordability and long-term financial commitment.

As noted above, the platform 120 may provide both an application that is designated specifically for consumers and an application that is designated specifically for agents and/or brokers. In some implementations, both applications may be functionally similar. In a further implementation, the application that is designated specifically for agents and/or brokers may allow for an estimation of sales prices for properties based on offer prices, time since offer, market conditions, and/or the like. In another implementation, the platform 120 may allow for messaging using its application, including messaging between multiple related buyers and an agent or broker, messaging between users and multiple vendors associated with a real estate transaction (e.g., a title agent), and/or the like.

In yet another implementation, the platform 120 may allow for an invitation to be sent to a prospective buyer by an agent or broker, where the invitation may be quick-response (QR) code or a hyperlink that invites the buyer to install the application mentioned above. The invitation may include metadata associated with the agent or broker. Once the application has been installed and activated by the buyer, the metadata may be used to facilitate a communication link between agent or broker who initiated the invitation and the buyer.

Similarly, in another implementation, the platform 120 may allow for a user 110 to refer a prospective buyer to a specific agent or broker by providing a similar invitation to the buyer. The invitation may include metadata associated with the user who provided the invitation. Once the application has been installed and activated by the buyer, the metadata may be used to inform the agent or broker that a specific user provided a referral to the buyer.

In an additional implementation, the platform 120 may be utilized by one or more public lenders and/or one or more private lenders to determine TCO values that a specific user can reasonably afford. Based on the determined TCO values, the one or more public lenders and/or one or more private lenders may determine a potential loan offering for the specific user.

In another implementation, the platform 120 may modify external data received from one or more external data providers 130, where such data may correspond to property insurance costs, utility costs, and a credit rating. In particular, the platform may modify such data based on real-time or near real-time changes to data involving the user 110. In such an implementation, these modifications may be performed via machine learning, neural networks, and/or the like.

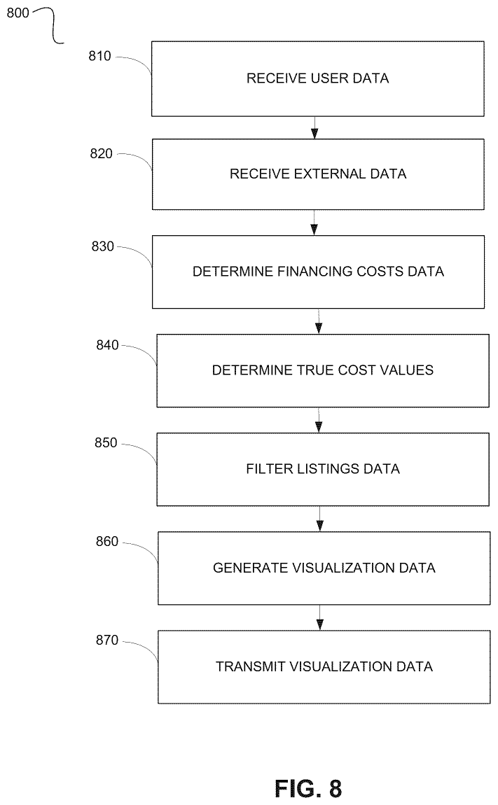

FIG. 8 illustrates a flow diagram of a method 800 for using a property market platform in accordance with implementations of various techniques described herein. In one implementation, method 800 may be at least partially performed by one or more computing systems, such as the platform 120 and/or the computing devices 111, 131 discussed above. It should be understood that while method 800 indicates a particular order of execution of operations, in some implementations, certain portions of the operations might be executed in a different order. Further, in some implementations, additional operations or steps may be added to the method 800. Likewise, some operations or steps may be omitted.

At block 810, the platform may receive user data from a user associated with a property transaction. As noted above, the platform may generate a user profile for the user based on the user data. In addition, the user data may include user profile data and user financing data.

At block 820, the platform may receive external data from the one or more external data providers for a plurality of properties. The external data may include listings data, local costs data, property financing data, and credit profile data. In particular, the local costs data may include data relating to one or more local costs for the properties, including costs relating to property taxes, property insurance, HOA fees, and utilities.

At block 830, the platform may determine the financing costs data corresponding to the user for the plurality of properties based on the user financing data, the listings data, the property financing data, and the credit profile data. At block 840, determine a plurality of true cost (TC) values for the plurality of properties based on the listings data, the local costs data, and the financing costs data.

At block 850, the platform may filter the listings data based on the plurality of TC values and filter input data. At block 860, the platform may generate visualization data based on the plurality of TC values and the filtered listings data. At block 870, the platform may transmit the visualization data to the computing device.

Accordingly, in view of the implementations discussed above with respect to FIGS. 1-8, a property marketplace platform may be utilized by a user to facilitate the purchase of one or more properties (e.g., one or more real estate properties). In particular, the platform may be configured to generate TC values for various properties, and the platform may then provide the generated TC values to the user.

Using the platform may allow users to input their down payment, credit rating, and mortgage product details to generate accurate, comprehensive calculations (e.g., TC values) for multiple properties, thereby allowing potential buyers to make informed decisions regarding their property expenses and/or purchases. For example, users can utilize the platform to calculate the monthly cost of homes for sale, including utilities, which may enable them to make more accurate financial decisions. Further, the users can utilize the search and/or filter features of the platform to curate all properties for sale based on that user's credit profile and/or a monthly price. These features may allow users to narrow down their search and focus on properties that meet their specific needs and budget.

In addition, users can utilize the platform to facilitate the task of calculating the total monthly cost of owning a property, including utilities, by leveraging user-provided data and real-time information. In doing so, the platform may allow users to avoid particular time-consuming tasks, such as performing manual calculations and research. Specifically, the platform may mitigate the need for manual calculations and extensive research, which may save users both time and effort. Instead of spending hours gathering information and performing calculations, users can rely on the platform to generate accurate and reliable results in less time.

Moreover, by accurately assessing the inclusive cost of all properties for sale, the platform may empower users to make informed and prudent financial decisions. Having a more accurate understanding of the monthly expenses associated with a particular property can help users assess their financial capabilities and determine if it fits within their budget. Specifically, by incorporating user input and real estate data, the platform may assist users in making informed financial decisions within the housing market. With the ability to streamline the transactional process, provide financial decision support, and enhance user experience, the platform may ensure that users have access to accurate and comprehensive information when making significant financial decisions.

### III. Computing System

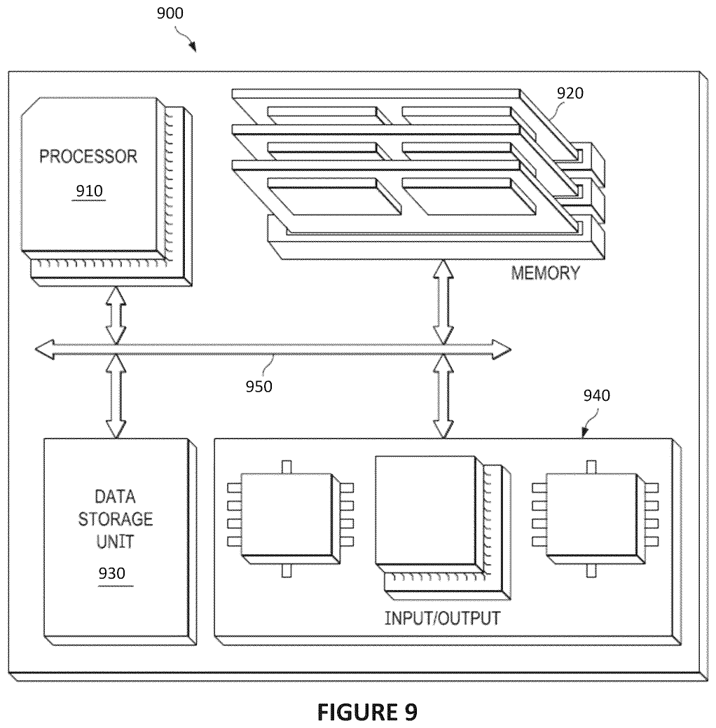

FIG. 9 illustrates a block diagram of a hardware configuration 900 in which one or more various technologies described herein may be incorporated and practiced. The hardware configuration 900 can be used to implement the one or more computing systems discussed above, such as the devices 111, 121, and 131. The hardware configuration 900 can include a processor 910, a memory 920, a storage device 930, and an input/output device 940. Each of the components 910, 920, 930, and 940 can, for example, be interconnected using a system bus 950. The processor 910 can be capable of processing instructions for execution within the hardware configuration 900. In one implementation, the processor 910 can be a single-threaded processor. In another implementation, the processor 910 can be a multi-threaded processor. The processor 910 can be capable of processing instructions stored in the memory 920 or on the storage device 930.

The memory 920 can store information within the hardware configuration 900. In one implementation, the memory 920 can be a computer-readable medium. In one implementation, the memory 920 can be a volatile memory unit. In another implementation, the memory 920 can be a non-volatile memory unit.

In some implementations, the storage device 930 can be capable of providing mass storage for the hardware configuration 900. In one implementation, the storage device 930 can be a computer-readable medium. In various different implementations, the storage device 930 can, for example, include a hard disk device/drive, an optical disk device, flash memory or some other large capacity storage device. In other implementations, the storage device 930 can be a device external to the hardware configuration 900. Various implementations for the memory 920 and/or the storage device 930 are further discussed below.

The input/output device 940 can provide input/output operations for the hardware configuration 900. In one implementation, the input/output device 940 can include one or more display system interfaces, sensors and/or data transfer ports.

The subject matter of this disclosure, and/or components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output thereby tying the process to a particular machine, e.g., a machine programmed to perform the processes described herein. The processes and logic flows can also be performed by, and apparatus can also be implemented as, special purpose logic circuitry, e.g., an FPGA (field programmable gate array) or an ASIC (application specific integrated circuit).

Computer readable media (e.g., memory 920 and/or the storage device 930) suitable for storing computer program instructions and data may include all forms of non-volatile memory, media, and memory devices, including, by way of example, any semiconductor memory devices (e.g., EPROM, EEPROM, solid state memory devices, and flash memory devices); any magnetic disks (e.g., internal hard disks or removable disks); any magneto optical disks; and any CD-ROM and DVD-ROM disks. The processor and the memory can be supplemented by, or incorporated in, special purpose logic circuitry.

The discussion above is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

While the foregoing is directed to implementations of various technologies described herein, other and further implementations may be devised without departing from the basic scope thereof. Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

What is claimed is:

1. A method, comprising:
receiving, at a property marketplace platform, external data from one or more external data systems for a plurality of properties, wherein the external data comprises listings data, local costs data, property financing data for the plurality of properties, and credit profile data corresponding to a user, and wherein the local costs data comprises data relating to one or more utilities expenses;
determining, by the property marketplace platform, financing costs data for the plurality of properties based on the listings data and the property financing data, wherein the financing costs data for a respective property corresponds to a value of a periodic financing cost associated with possessing the respective property;
determining, by the property marketplace platform, a plurality of true cost (TC) values for the plurality of properties based on the listings data, the local costs data, and the financing costs data, wherein a respective TC value for the respective property corresponds to a value of a total periodic cost associated with possessing the respective property;
generating, by the property marketplace platform, visualization data based on the plurality of TC values and the listings data, wherein the visualization data is configured for use in generating one or more interfaces for a user device associated with the user; and
transmitting, from the property marketplace platform, the visualization data to the user device.

2. The method of claim 1, wherein determining, by the property marketplace platform, the financing costs data for the plurality of properties comprises:
receiving user financing data from the user device, wherein the user financing data corresponds to selections by the user for a credit rating, a down payment value, and a loan product;
determining the financing costs data corresponding to the user for the plurality of properties based on the user financing data, the listings data, the property financing data, and the credit profile data.

3. The method of claim 2, wherein determining, by the property marketplace platform, the plurality of TC values comprises determining the plurality of TC values corresponding to the user for the plurality of properties based on the listings data, the local costs data, and the financing costs data corresponding to the user.

4. The method of claim 1, wherein generating, by the property marketplace platform, the visualization data comprises:
receiving, by the property marketplace platform, filter input data from the communications device, wherein the filter input data corresponds to one or more criterion selected by the user for filtering the listings data, and wherein the one or more criterion comprise a maximum TC value for the user, a minimum TC value for the user, or combinations thereof.

5. The method of claim 4, wherein generating, by the property marketplace platform, the visualization data further comprises:
filtering, by the property marketplace platform, the listings data based on the plurality of TC values and the filter input data; and
generating, by the property marketplace platform, the visualization data based on the filtered listings data and the plurality of TC values, wherein the filtered listings data corresponds to at least a subset of the plurality of properties.

6. The method of claim 1, wherein determining, by the property marketplace platform, the plurality of TC values comprises:
determining default selections corresponding to a credit rating, a down payment value, and a loan type based on the property financing data; and
determining the plurality of TC values based on the external property data and the determined default selections.

7. The method of claim 1, wherein the plurality of TC values comprises a plurality of true cost of ownership (TCO) values.

8. The method of claim 1, wherein the plurality of TC values comprises a plurality of true cost of rent (TCR) values.

9. A property marketplace platform, comprising:
one or more processors; and
a memory comprising a plurality of program instructions which, when executed by the one or more processors, cause the one or more processors to:
receive external data from one or more external data systems for a plurality of properties, wherein the external data comprises listings data, local costs data, property financing data for the plurality of properties, and credit profile data corresponding to a user, and wherein the local costs data comprises data relating to one or more utilities expenses;
determine financing costs data for the plurality of properties based on the listings data and the property financing data, wherein the financing costs data for a respective property corresponds to a value of a periodic financing cost associated with possessing the respective property;
determine a plurality of true cost (TC) values for the plurality of properties based on the listings data, the local costs data, and the financing costs data, wherein a respective TC value for the respective property corresponds to a value of a total periodic cost associated with possessing the respective property;
generate visualization data based on the plurality of TC values and the listings data, wherein the visualization data is configured for use in generating one or more interfaces for a user device associated with the user; and
transmit the visualization data to the user device.

10. The property marketplace platform of claim 9, wherein determine the financing costs data for the plurality of properties comprises:
receive user financing data from the user device, wherein the user financing data corresponds to selections by the user for a credit rating, a down payment value, and a loan product;
determine the financing costs data corresponding to the user for the plurality of properties based on the user financing data, the listings data, the property financing data, and the credit profile data.

11. The property marketplace platform of claim 10, wherein determine the plurality of TC values comprises determine the plurality of TC values corresponding to the user for the plurality of properties based on the listings data, the local costs data, and the financing costs data corresponding to the user.

12. The property marketplace platform of claim 9, wherein generate the visualization data comprises:
receive filter input data from the communications device, wherein the filter input data corresponds to one or more criterion selected by the user for filtering the listings data, and wherein the one or more criterion comprise a maximum TC value for the user, a minimum TC value for the user, or combinations thereof.

13. The property marketplace platform of claim 12, wherein generate the visualization data further comprises:
filter the listings data based on the plurality of TC values and the filter input data; and
generate the visualization data based on the filtered listings data and the plurality of TC values, wherein the filtered listings data corresponds to at least a subset of the plurality of properties.

14. The property marketplace platform of claim 9, wherein determine the plurality of TC values comprises:
determine default selections corresponding to a credit rating, a down payment value, and a loan type based on the property financing data; and
determine the plurality of TC values based on the external property data and the determined default selections.

15. The property marketplace platform of claim 9, wherein the plurality of TC values comprises a plurality of true cost of ownership (TCO) values.

16. The property marketplace platform of claim 9, wherein the plurality of TC values comprises a plurality of true cost of rent (TCR) values.

17. A non-transitory computer-readable medium having stored thereon a plurality of computer-executable instructions which, when executed by a computer, cause the computer to:
receive external data from one or more external data systems for a plurality of properties, wherein the external data comprises listings data, local costs data, property financing data for the plurality of properties, and credit profile data corresponding to a user, and wherein the local costs data comprises data relating to one or more utilities expenses;
determine financing costs data for the plurality of properties based on the listings data and the property financing data, wherein the financing costs data for a respective property corresponds to a value of a periodic financing cost associated with possessing the respective property;
determine a plurality of true cost (TC) values for the plurality of properties based on the listings data, the local costs data, and the financing costs data, wherein a respective TC value for the respective property corresponds to a value of a total periodic cost associated with possessing the respective property;
generate visualization data based on the plurality of TC values and the listings data, wherein the visualization data is configured for use in generating one or more interfaces for a user device associated with the user; and
transmit the visualization data to the user device.

18. The non-transitory computer-readable medium of claim 17, wherein determine the financing costs data for the plurality of properties comprises:
receive user financing data from the user device, wherein the user financing data corresponds to selections by the user for a credit rating, a down payment value, and a loan product;
determine the financing costs data corresponding to the user for the plurality of properties based on the user financing data, the listings data, the property financing data, and the credit profile data.

19. The non-transitory computer-readable medium of claim 18, wherein determine the plurality of TC values comprises determine the plurality of TC values corresponding to the user for the plurality of properties based on the listings data, the local costs data, and the financing costs data corresponding to the user.

20. The non-transitory computer-readable medium of claim 19, wherein generate the visualization data comprises:
receive filter input data from the communications device, wherein the filter input data corresponds to one or more criterion selected by the user for filtering the listings data, and wherein the one or more criterion comprise a maximum TC value for the user, a minimum TC value for the user, or combinations thereof.
